(19) United States
(12) Patent Application Publication
(10) Pub. No.: US 2016/0362024 A1
(43) Pub. Date: Dec. 15, 2016

(54) BABY SWADDLE FOR CHILD RESTRAINT SEATS AND METHOD

(71) Applicant: The Cocoon Company LLC, Huntersville, NC (US)

(72) Inventors: Jenny Elizabeth Simon, Huntersville, NC (US); Lauren Adele Davis, Winterville, NC (US)

(21) Appl. No.: 15/180,660

(22) Filed: Jun. 13, 2016

Related U.S. Application Data
(60) Provisional application No. 62/174,090, filed on Jun. 11, 2015.

(51) Int. Cl. B60N 2/28; A47D 15/00; A47G 9/02

(52) U.S. Cl. CPC B60N 2/2812; A47G 9/0223; A47D 15/005; B60N 2002/2815

(57) ABSTRACT

A baby swaddle for use in child restraint seats, and method of use, is disclosed. The baby swaddle is designed to be used in combination with standard five point harnesses. The baby swaddle can include a back portion with one or more openings through which the straps of the five point harness may be pulled. The quilted back can be flanked by two wings or flaps that can be wrapped snuggly around the baby. Further, the baby swaddle can include a foot pocket for holding a blanket. A method of using the baby swaddle is provided.

### CROSS REFERENCE TO RELATED APPLICATIONS

This application claims the benefit of U.S. Provisional Patent Application No. 62/174,090, filed Jun. 11, 2015, the entirety of which is incorporated herein by reference.

### TECHNICAL FIELD

The presently disclosed subject matter relates generally to child restraint systems and more particularly to a baby swaddle for use in child restraint seats, such as a car seats and strollers.

### BACKGROUND

Babies (e.g., infants), particularly very young children, are often more comfortable and content when swaddled in a blanket. The security and warmth offered by a swaddle put an infant at ease and make caring for them easier. Conversely, babies are often uncomfortable and unhappy when fastened into a child restrain seat, such as a car seat or stroller. Conventional car seats, strollers, and the like that require one or more restraints to secure the child make safely swaddling the baby while secured impossible. Consequently, when fastened into the child restrain seat, babies are often fussy, causing stress for both the baby and the baby's caretaker. Therefore, child restraint seats, strollers, and the like could benefit from mechanisms that enable the baby to be both securely fastened to the seat/stroller, but also enable the baby to be swaddled, and therefore happy and content.

### SUMMARY

In various embodiments, a baby swaddle device for use in child restraint seats is provided. In some embodiments, the device includes a back portion, a foot pocket, a first wing, and a second wing. The back portion may also include one or more openings for passing restraints of a child restraint seat through the back portion to engage a child to be secured therein.

In various other embodiments, the back portion may include a single relatively large opening for passing restraints of a child restraint seat through the back portion to engage the child to be secured therein. The one or more holes or openings may have an elastic component, for example, that allows the one or more holes to stretch from a first static position to a second stretched position. The device may also include a blanket coupled to the foot pocket such that it may securely cover a child placed therein. The blanket may also be configured to be folded and stored in the foot pocket when not in use. Further, the foot pocket may include an elastic opening. In some embodiments, the swaddle device is composed primarily of soft material, such as, for example, cotton or bamboo rayon material. Additional padding material may be added if desired.

In some embodiments, the one or more openings for passing the restraints of the child restraint seat may be positioned such that they substantially correspond with a standard five-point harness system. In particular, in some embodiments, the openings may include two openings positioned substantially along the length of either side of the back of a child installed in the device so as to receive shoulder straps, and a third slit positioned between an upper portion of the child's legs (i.e. crotch area) so as to receive a crotch strap. Other embodiments may include only a single relatively large opening centered substantially at a midpoint of the child restraint seat's restraint harness.

The first and second wings can extend from the back portion and may be wrapped around a child installed in the device. In some embodiments, the second wing may be secured to the first wing, when installed, via a fastener. Exemplary fasteners include, but are not limited to, a hook-and-loop system (i.e. Velcro®), snaps, hooks, buttons, zippers, ties, and the like. In certain other embodiments, the first and second wings are secured using the body weight of the child installed therein.

Also disclosed is a method of using the presently disclosed swaddle device. The method may include, but is not limited to, the steps of placing the swaddle device in a child restraint seat, passing the restraints of the child restraint seat through slits and/or openings or holes in the device, placing a baby on the baby swaddle device and child restraint seat, securing the baby to the child restraint seat and swaddle device using the restraints, pulling the blanket securely over the baby's body, wrapping the first wing across the baby's body and securing it on the opposite side, and wrapping the second wing across the baby's body and securing it on the opposite side. The method may further include the steps of inserting the baby's feet into the foot pocket. The method may be re-ordered slightly as well, such that the baby is installed in the child restraint system first, and properly secured therein, before installing the swaddle device by, for example, passing the swaddle device over the baby through a single relatively large opening in the back portion of the swaddle device.

### BRIEF DESCRIPTION OF THE DRAWINGS

Having thus described the presently disclosed subject matter in general terms, reference will now be made to the accompanying Drawings, which are not necessarily drawn to scale, and wherein:

FIG. 1 illustrates a plan view of an example of the presently disclosed baby swaddle for use in combination with child restraint seats;

FIG. 2 illustrates a flow diagram of an example of a method of using the presently disclosed baby swaddle in combination with a child restraint seat;

FIG. 3 through FIG. 7 illustrate the steps of using the presently disclosed baby swaddle for use in combination with child restraint seats.

FIG. 8 through FIG. 10 illustrate a plan view of an example of the presently disclosed baby swaddle for use in combination with child restraints seats having a single large opening in the back portion.

### DETAILED DESCRIPTION

The presently disclosed subject matter now will be described more fully hereinafter with reference to the accompanying Drawings, in which some, but not all embodiments of the presently disclosed subject matter are shown. Like numbers refer to like elements throughout. The presently disclosed subject matter may be embodied in many different forms and should not be construed as limited to the embodiments set forth herein; rather, these embodiments are provided so that this disclosure will satisfy applicable legal requirements. Indeed, many modifications and other embodiments of the presently disclosed subject matter set forth herein will come to mind to one skilled in the art to which the presently disclosed subject matter pertains having the benefit of the teachings presented in the foregoing descriptions and the associated Drawings. Therefore, it is to be understood that the presently disclosed subject matter is not to be limited to the specific embodiments disclosed and that modifications and other embodiments are intended to be included within the scope of the appended claims.

In some embodiments, the presently disclosed subject matter provides a baby swaddle for use in a child restraint seat, such as, but not limited to, a car seat, stroller, and the like, and a method of using the baby swaddle. The presently disclosed baby swaddle provides a way to swaddle the baby in a child restraint seat while also keeping them safely fastened therein. Namely, the baby swaddle is designed to be used in combination with child seat restraints (e.g., standard five point harnesses used in typical child restraint seats). The comfort and security that the baby swaddle provides while installed in the child restraint seat can help to keep a baby happy and content while safely fastened into any standard child restraint seat.

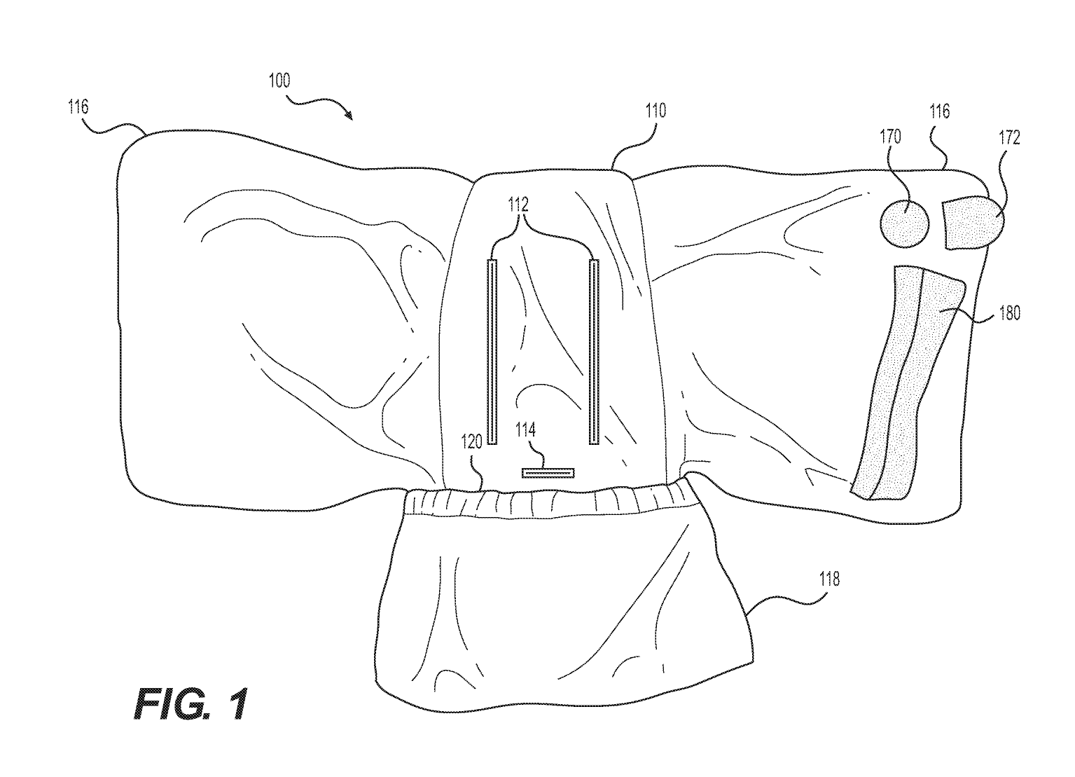

Referring now to FIG. 1, a plan view is shown of one example of the presently disclosed baby swaddle 100 that can be used in child restraint seats, such as, but not limited to, car seats and strollers. In various embodiments, the baby swaddle 100 can include a quilted back 110, or other suitable material, which is the main body of the baby swaddle 100. To accommodate the harness of a child restraint seat, slits or openings may be provided in the quilted back 110 through which the straps of the harness (e.g. a standard five point harness) may be pulled. For example, two openings or slits 112 may be provided that correspond to the two shoulder/waist straps of the five point harness, and a slit 114 may be provided that corresponds to the crotch strap of the five point harness. The slits 112 and 114 may be of any suitable length and width to accommodate varying straps found in child restraint seats. For example, slits 112 may extend from approximately shoulder level of a child situated in the device to approximately the waist of a child situated in the device. In some embodiments, slits 112 may be approximately 4 to 8 inches in length. In other embodiments, the slits 112 may be any other appropriate length, depending on the size of the device. Slit 114 may be substantially horizontal and generally perpendicular to the slits 112, and positioned below the slits 112. The slits 112 and 114 may also include elastic or other suitable materials capable of keeping the slits in close proximity to the straps passing there through.

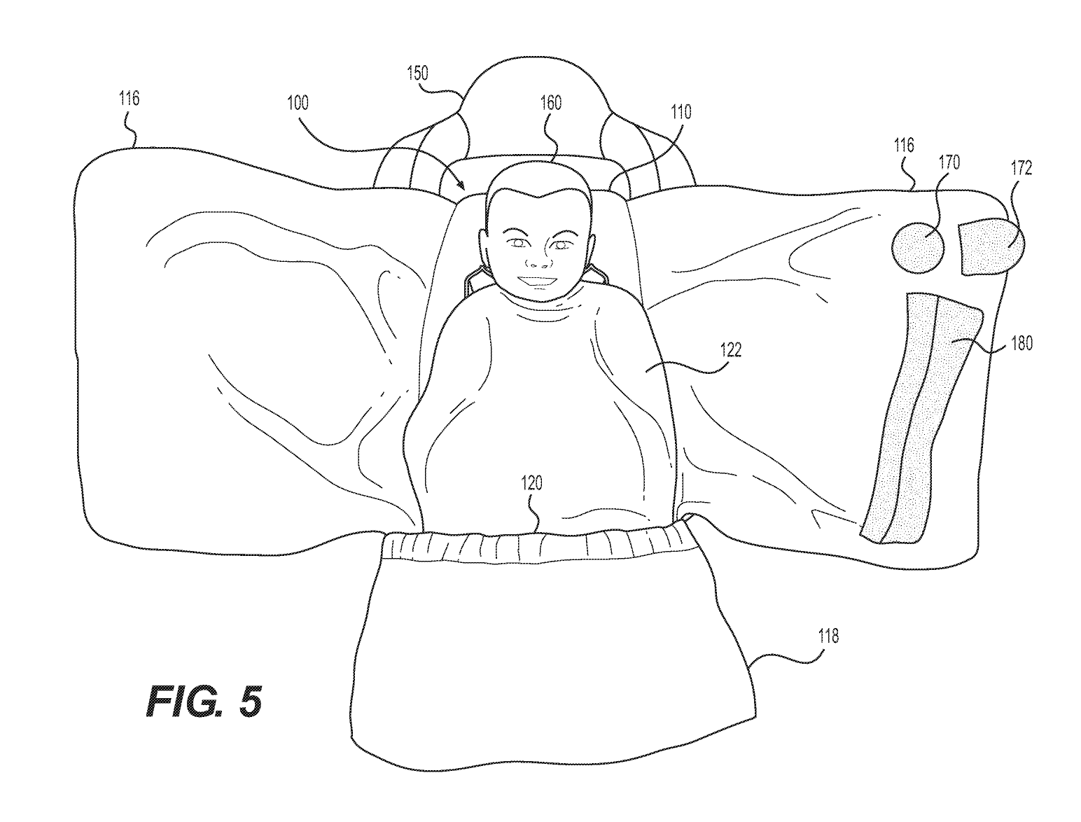

The quilted back 110 may also be flanked by two wings or flaps 116. The two wings or flaps 116 can be wrapped snuggly around the baby, when desired. A foot pocket 118 may also be provided at a lower end of the quilted back 110 (e.g., near the baby's feet). The foot pocket 118 can be, in some embodiments, an elastic pouch that has an elastic (or other suitable) opening 120. The foot pocket 118 may also include a blanket (e.g., blanket 122 shown in FIG. 5) that is configured to pull out over the baby (through, for example, the opening 120). The blanket (e.g., blanket 122 shown in FIG. 5) may be stored inside the foot pocket 118 when the baby is not being swaddled. The foot pocket 118 may also be used, while the baby is being swaddled (or otherwise), as a pouch for the feet to help secure the feet from coming out of the baby swaddle 100.

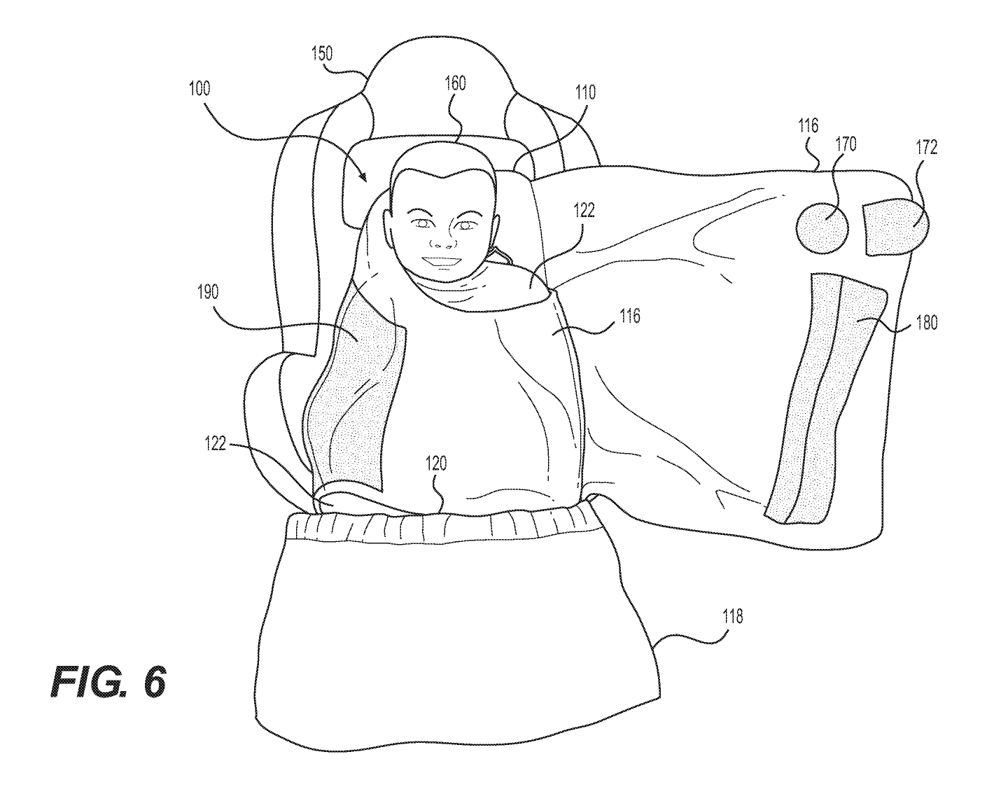

The size and/or span of the two wings or flaps 116 and the blanket (e.g., blanket 122 shown in FIG. 5) can vary depending on the size of the baby to be swaddled. Indeed, sizing can range from sizes appropriate for newborns all the way up to toddlers and other small children. Additionally, the quilted back 110, the two wings or flaps 116, and the blanket (e.g., blanket 122 shown in FIG. 5) may be made of various types of fabric. In one example, the two wings or flaps 116 and the blanket (e.g., blanket 122 shown in FIG. 5) are made of bamboo rayon fiber fabric. The bamboo rayon fiber fabric is a breathable fabric that will allow the baby to stay warm in the winters and cool in the summers. Of course, any other suitable fabric will suffice, including cotton, cotton-blends, and the like, In one example, the blanket (e.g. blanket 122) can be pulled out over the baby, then the two wings or flaps 116 can be wrapped snuggly around the baby and held using fasteners (such as, for example, fasteners 170, 172, 180, and 190 (see, e.g., FIG. 6)).

In one example, the fasteners are a hook-and-loop system, such as, for example, Velcro®. For example, the “loop” component can be integrated into a first flap 116 at, for example, receiving portion 190 in FIG. 6, and the “hook” component of Velcro® can be integrated into a second flap 116 at attaching portions 170, 172, and/or 180. However, the two wings or flaps 116 can be fastened by any means desired, such as snaps, hooks, buttons, zippers, ties, and the like, as long as the fasteners pose no danger to the baby. Additionally, other fasteners (e.g., Velcro®) can be provided on the inside edge of the child restraint seat and on the wings or flaps 116 to secure the wings or flaps 116 to the child restraint seat when the baby swaddle 100 is not in use. Further still, the wings or flaps 116 may, in some embodiments, be secured without fasteners by tucking them under the baby, using the baby's body weight and/or the forces of the child restraint system to secure the wings or flaps 116.

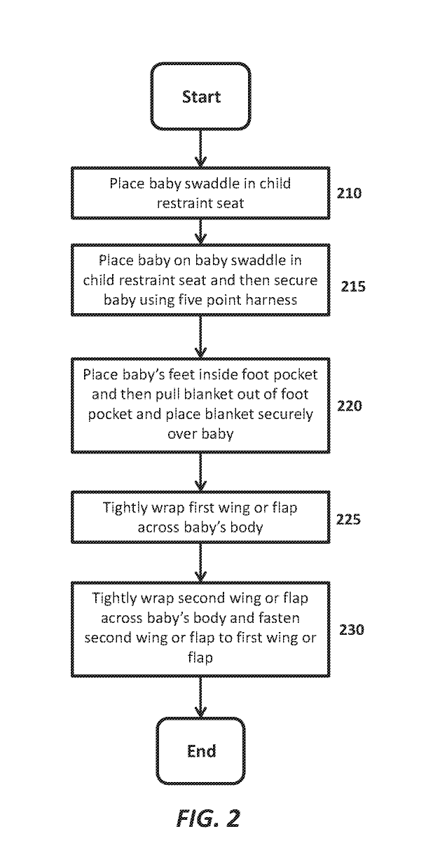

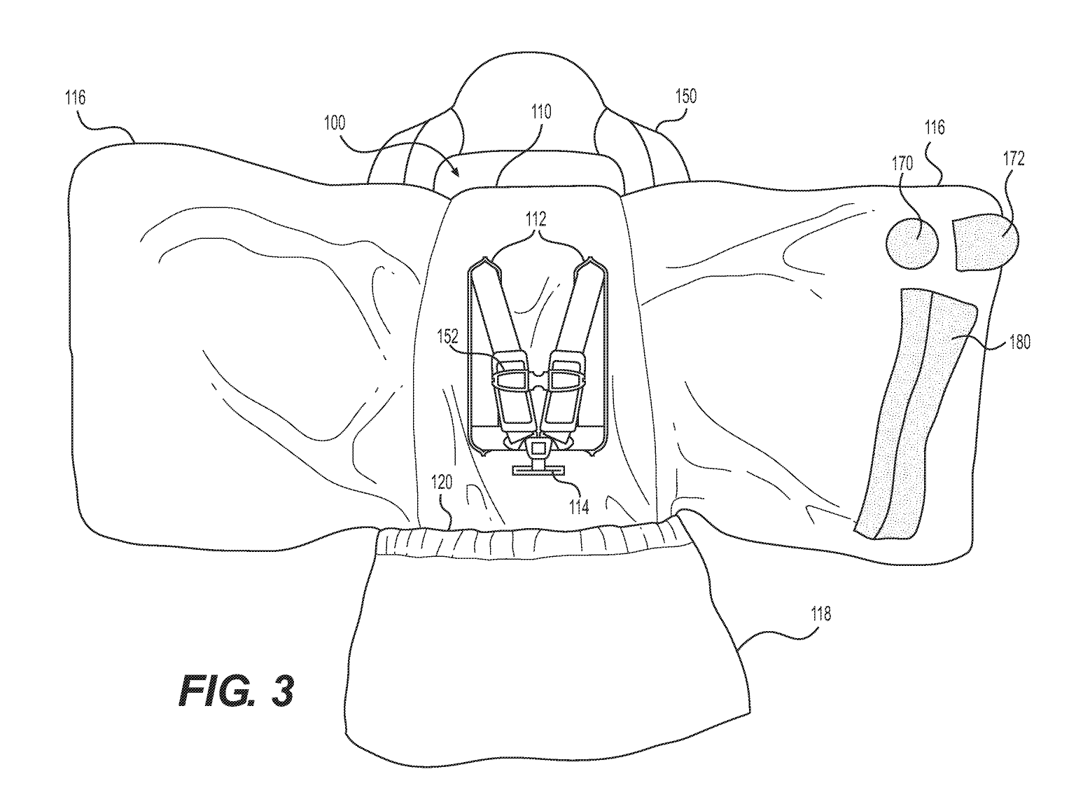

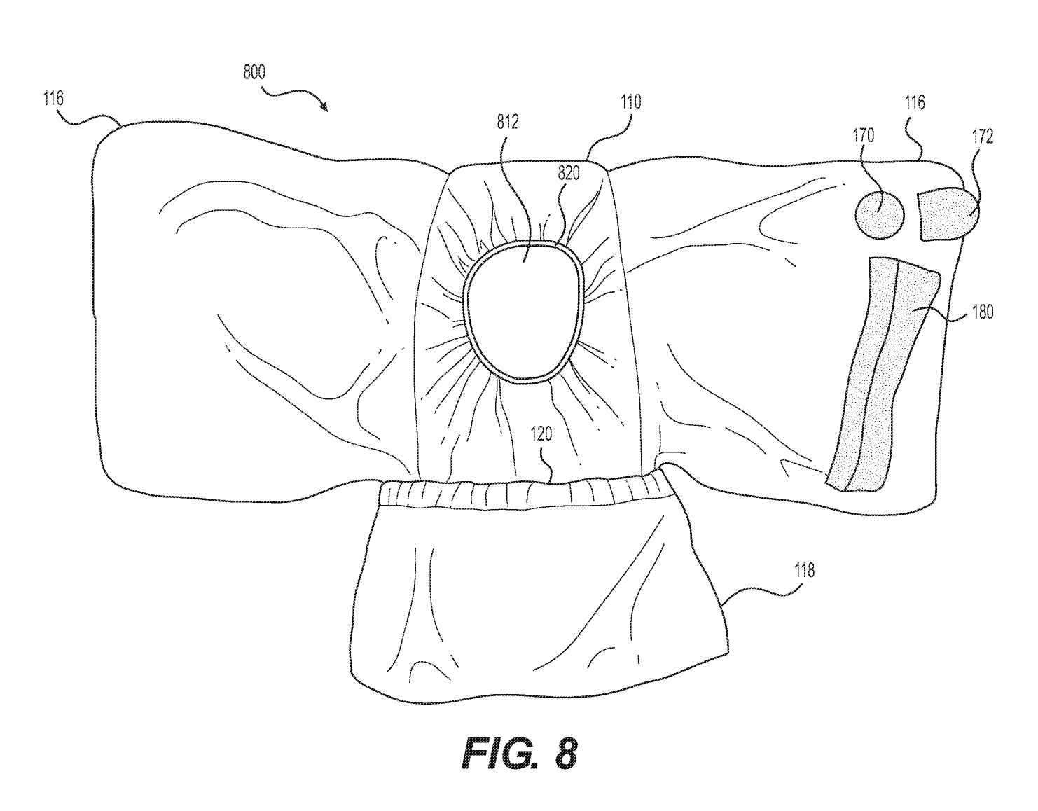

Referring now to FIG. 2, a flow diagram is presented of an example of a method 200 of using the presently disclosed baby swaddle 100 in combination with a child restraint seat. The method 200 may include, but is not limited to, the following steps (which reference FIG. 3 through FIG. 7). Note that method 200 is also generally applicable to the exemplary swaddle illustrated in FIG. 8 through FIG. 10. In such embodiments, the method 200 may be re-ordered such that, for example, the baby is securely installed in the child restraint seat before installing the swaddle device.

At a step 210, the baby swaddle 100 is placed in a child restraint seat. For example and referring now to FIG. 3, the baby swaddle 100 may be placed in a car seat 150 that includes a five point harness 152. Namely, the two shoulder straps of the five point harness 152 are pulled through the two slits 112 in the baby swaddle 100. Further, the crotch strap of the five point harness 152 is pulled through the slit 114 in the baby swaddle 100.

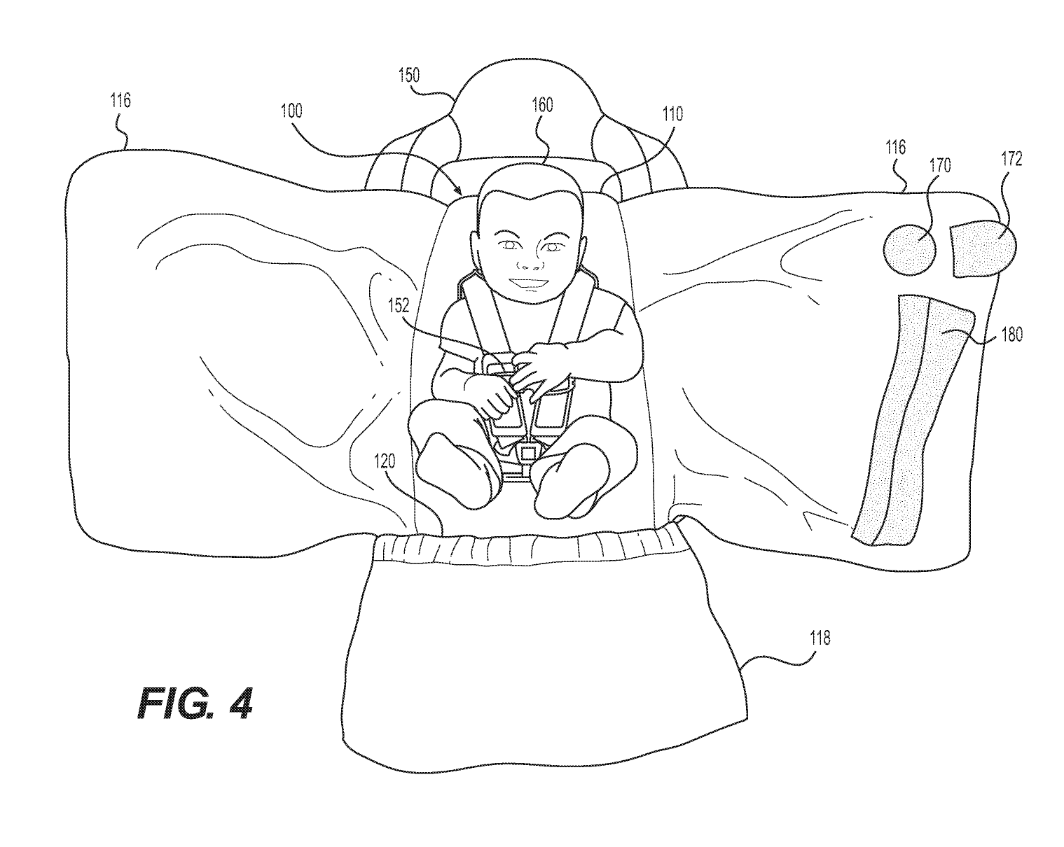

At a step 215, a baby is placed on the baby swaddle 100 in the child restraint seat 150 and then secured using the five point harness. For example, and referring now to FIG. 4, a baby 160 may be placed on the baby swaddle 100 in the car seat 150 and then secured using the five point harness 152. In some embodiments, this step may be performed first, with the swaddle device added after baby is securely installed in the child restraint seat (see, e.g., FIGS. 8-10).

At a step 220, the baby's feet are placed inside the foot pocket and the blanket is pulled out of the foot pocket and placed securely over the baby. For example, and referring now to FIG. 5, the baby's feet may be placed inside the foot pocket 118 and the blanket 122 is placed securely over the baby 160. For small babies, the baby's feet may not yet reach the foot pocket 118.

At a step 225, the first wing or flap 116 is tightly wrapped across the baby's body and then tucked under the opposite side of the baby or otherwise secured to help secure the baby. For example, and referring now to FIG. 6, the right side-wing or flap 116 may be tightly wrapped across the baby's body (and optionally over the blanket 122) and then tucked under the left side of the baby 160 to help secure the baby 160. Note that the right side-wing or flap 116 may also be secured using a fastener as discussed above.

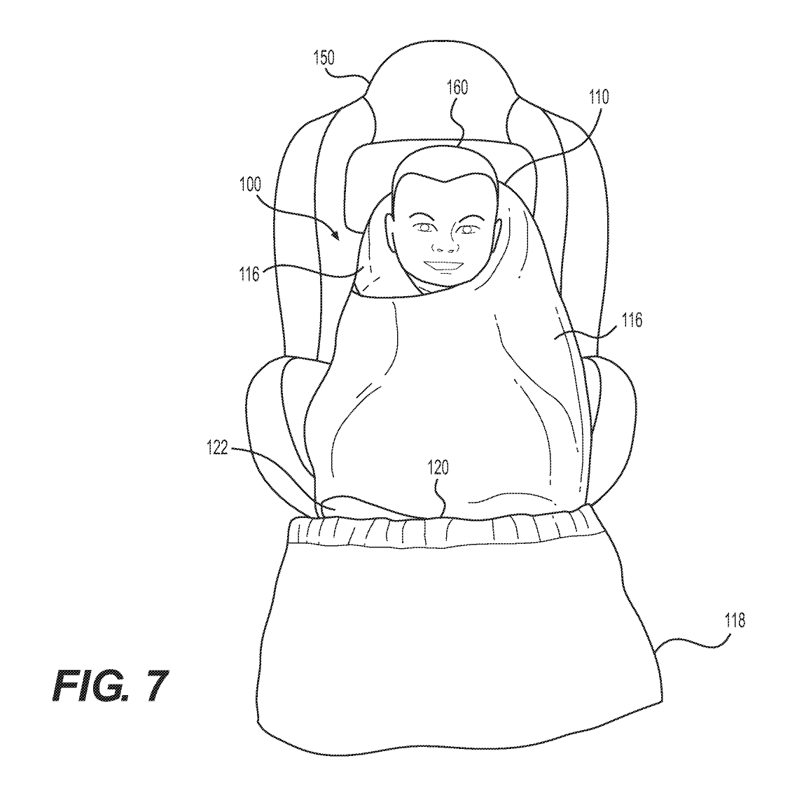

At a step 230, the second wing or flap 116 is tightly wrapped across the baby's body and secured. For example, and referring now to FIG. 7, the left side-wing or flap 116 may be tightly wrapped across the baby's body (and over the first right side-wing or flap 116) and then fastened to the first right side-wing or flap 116 to help secure the baby 160. In one example, the left side-wing or flap 116 is fastened to the right side-wing or flap 116 using Velcro® (e.g., “loop” Velcro® portion 190 and “hook” Velcro® portion 170, 172, and/or 180). In certain other examples, the second left-side wing or flap may be secured by tucking it under the baby. At the completion of this step, using the five point harness 152 and the baby swaddle 100, the baby 160 is snug and safely secure inside the car seat 150 in a manner that helps keep the baby 160 swaddled, and therefore happy and content in the car seat 150.

In the method 200, it is important to never swaddle a baby into a child restraint seat without first securing the five point harness around the baby. The presently disclosed baby swaddle 100 alone is not intended to secure the baby into the child restraint seat. Note further that the method 200 discussed above may also be executed by starting with the left-side wing or flap 116 rather than the right side, if desired.

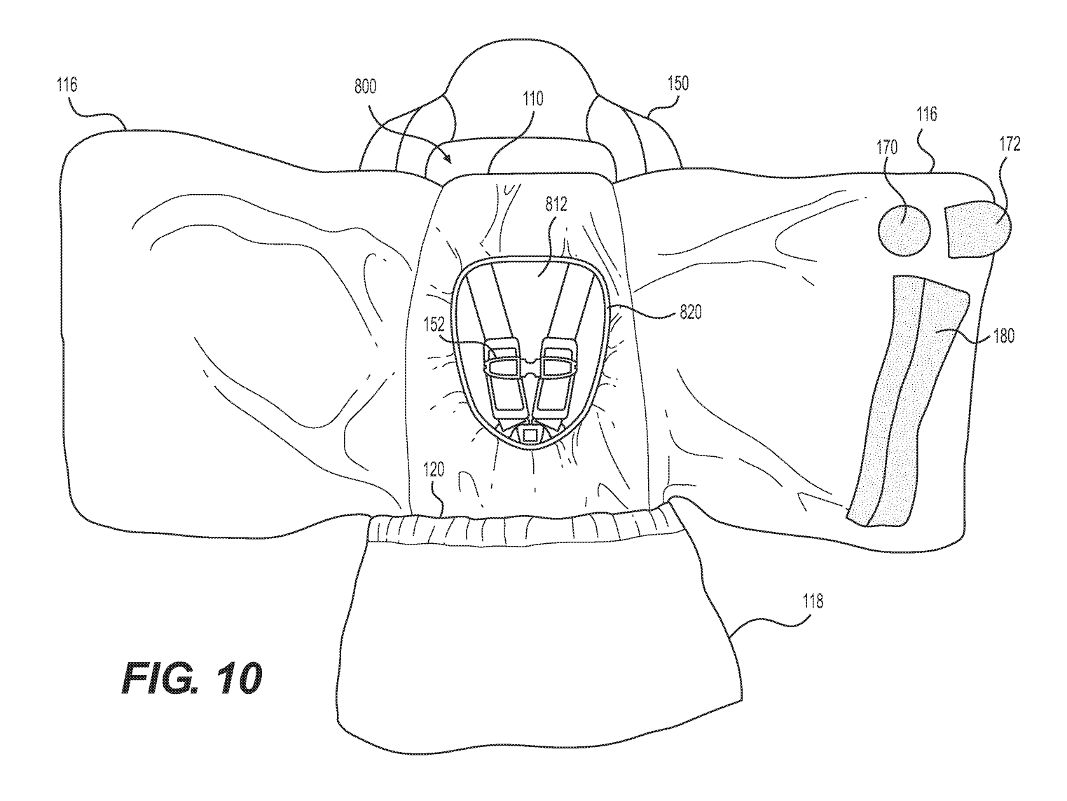

In various embodiments, the method 200 disclosed above may be modified to make use of other embodiments of the presently disclosed baby swaddle device, such as, for example, swaddle 800 shown in FIG. 8. In such embodiments, the slits 112 and 114 of swaddle 100 may be replaced with a single opening 812. Opening 812 can be sized to have a diameter approximate to that of the distance between the shoulder straps and the crotch strap of the child restraint device (e.g., child seat 150 illustrated in FIG. 10). Consequently, rather than pass the child restraint straps 152 through a plurality of slits, the swaddle 800 may simply be placed in the car seat and the straps pass through the swaddle entirely, enabling the baby to be secured to the car seat without any additional material between the baby and the child restraints.

Swaddle 800, and more particularly, opening 812, may further include an elastic or otherwise stretchable material 820 so as to enable a user to stretch the opening 812 around the child restraint straps 152. The opening 812 may also be sized such that the baby can be secured in the child restraint seat (e.g., child seat 150) first, and only then have the swaddle 800 installed (by, for example, passing the swaddle device over the baby and restraint system).

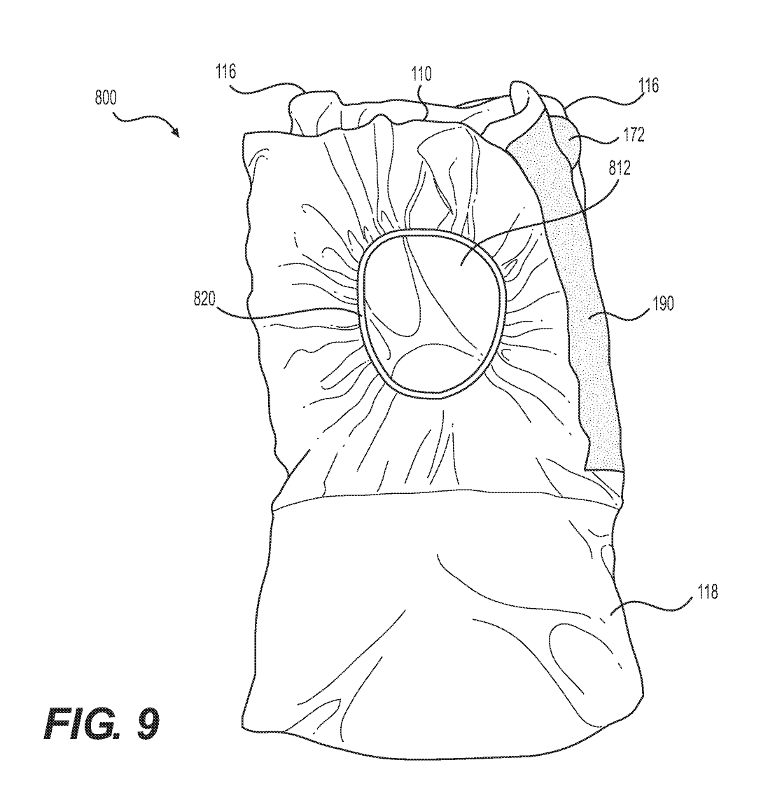

Referring now to FIG. 9, a view of swaddle 800 is presented from a rearward side, showing the back of swaddle 800. FIG. 9 also illustrates an exemplary embodiment of swaddle 800 with the first and second arms 116 folded across one another as they would be if a baby were being wrapped therein. FIG. 10 is similar to FIG. 3, but for illustrating swaddle 800 and opening 812 instead of swaddle 100 and its various slits 112 and 114.

Following long-standing patent law convention, the terms “a,” “an,” and “the” refer to “one or more” when used in this application, including the claims. Thus, for example, reference to “a subject” includes a plurality of subjects, unless the context clearly is to the contrary (e.g., a plurality of subjects), and so forth.

Throughout this specification and the claims, the terms “comprise,” “comprises,” and “comprising” are used in a non-exclusive sense, except where the context requires otherwise. Likewise, the term “include” and its grammatical variants are intended to be non-limiting, such that recitation of items in a list is not to the exclusion of other like items that can be substituted or added to the listed items.

For the purposes of this specification and appended claims, unless otherwise indicated, all numbers expressing amounts, sizes, dimensions, proportions, shapes, formulations, parameters, percentages, quantities, characteristics, and other numerical values used in the specification and claims, are to be understood as being modified in all instances by the term “about” even though the term “about” may not expressly appear with the value, amount or range. Accordingly, unless indicated to the contrary, the numerical parameters set forth in the following specification and attached claims are not and need not be exact, but may be approximate and/or larger or smaller as desired, reflecting tolerances, conversion factors, rounding off, measurement error and the like, and other factors known to those of skill in the art depending on the desired properties sought to be obtained by the presently disclosed subject matter. For example, the term “about,” when referring to a value can be meant to encompass variations of, in some embodiments, ±100% in some embodiments +50%, in some embodiments ±20%, in some embodiments +10%, in some embodiments ±5%, in some embodiments +1%, in some embodiments ±0.5%, and in some embodiments +0.1% from the specified amount, as such variations are appropriate to perform the disclosed methods or employ the disclosed compositions.

Further, the term “about” when used in connection with one or more numbers or numerical ranges, should be understood to refer to all such numbers, including all numbers in a range and modifies that range by extending the boundaries above and below the numerical values set forth. The recitation of numerical ranges by endpoints includes all numbers, e.g., whole integers, including fractions thereof, subsumed within that range (for example, the recitation of 1 to 5 includes 1, 2, 3, 4, and 5, as well as fractions thereof, e.g., 1.5, 2.25, 3.75, 4.1, and the like) and any range within that range.

Although the foregoing subject matter has been described in some detail by way of illustration and example for purposes of clarity of understanding, it will be understood by those skilled in the art that certain changes and modifications can be practiced within the scope of the appended claims.

That which is claimed:

1. A baby swaddle device for use in child restraint seats, the device comprising a back portion, a foot pocket, a first wing, and a second wing; the back portion further comprising one or more openings for passing restraints of a child restraint seat through the back portion to engage a child to be secured therein.

2. The device of claim 1, wherein the one or more openings comprise a plurality of slits.

3. The device of claim 2 wherein the plurality of slits passing through the back portion comprise two upper slits extending in a substantially vertical direction, and a third slit positioned substantially below and substantially perpendicular to the two upper slits, the upper slits configured to receive shoulder straps from the child restraint seat and the third slit configured to receive the crotch strap from the child restraint seat.

4. The device of claim 1, wherein the one or more openings comprise a single opening.

5. The device of claim 4, wherein the single opening is sized to fit around the restraints of the child restraint seat.

6. The device of claim 1, wherein the one or more openings comprise a stretchable material around a perimeter of the one or more openings.

7. The device of claim 1 further comprising a blanket, wherein the blanket is secured to the foot pocket substantially along one edge of the blanket and is further capable of being folded and stored within the foot pocket.

8. The device of claim 1 wherein the foot pocket comprises an elastic opening.

9. The device of claim 1 wherein the back portion, foot pocket, first wing, and second wing comprise a substantially cotton material.

10. The device of claim 1 wherein the back portion, foot pocket, first wing, and second wing comprise a substantially bamboo rayon material.

11. The device of claim 1, wherein the foot pocket is positioned at a lower portion of the back portion so as to receive the feet of the child to be secured therein.

12. The device of claim 1 wherein the back portion comprises additional padding material.

13. The device of claim 1 wherein the first wing and the second wing further comprise fasteners to secure the first wing to the second wing when the wings are installed around the child.

14. The device of claim 13 wherein the fasteners comprise one or more of a hook-and-loop system, snaps, hooks, buttons, zippers, or ties.

15. A method of using a baby swaddle device for use in child restraint seats, the method comprising the steps of:
a. placing a baby swaddle device in a child restraint seat, the baby swaddle device comprising a back portion, a foot pocket, a first wing, a second wing, and a blanket, wherein the blanket is coupled to the foot pocket substantially along one edge of the blanket, and further wherein the back portion further comprises a plurality of openings for passing restraints of the child restraint seat through the back portion to engage a child to be secured therein;
b. placing a baby on the baby swaddle device in the child restraint seat;
c. securing the baby to the child restraint seat and swaddle device using the restraints of the child restraint seat;
d. pulling the blanket over the baby's body;
e. wrapping the first wing across the baby's body and securing it on the opposite side;
f. wrapping the second wing across the baby's body and securing it on the opposite side.

16. The method of claim 15 further comprising the step of placing the baby's feet in the foot pocket prior to pulling the blanket over the baby's body.

17. The method of claim 15, wherein the second wing is secured to the swaddle device using a fastener.

18. The method of claim 17, wherein the second wing comprises the fastener.

19. The method of claim 17 wherein the fastener comprises one or more of a hook-and-loop system, snaps, hooks, buttons, zippers, or ties.

20. A method of placing a baby swaddle device in a child restraint seat, the baby swaddle device comprising a back portion, a foot pocket, a first wing, a second wing, and a blanket, wherein the blanket is coupled to the foot pocket substantially along one edge of the blanket, and further wherein the back portion further comprises an opening for passing restraints of the child restraint seat through the back portion to engage a child to be secured therein;
a. placing a baby in a child restraint seat and securing the baby to the child restraint seat using the restraints of the child restraint seat;
b. placing the baby swaddle device around the baby and around the restraints of the child restraint seat such that the opening extends around the baby and rests behind the baby and around the restraints of the child restraint seat;
c. pulling the blanket over the baby's body;
d. wrapping the first wing across the baby's body and securing it on the opposite side;
e. wrapping the second wing across the baby's body and securing it on the opposite side.
